(19) United States
(12) Patent Application Publication
(10) Pub. No.: US 2015/0147257 A1
(43) Pub. Date: May 28, 2015

(54) FLUID CAPTURE OF NANOPARTICLES

(71) Applicant: DOW CORNING CORPORATION, Midland, MI (US)

(72) Inventors: Jeffrey Anderson, Midland, MI (US); James A. Casey, Merrill, MI (US); Vasgen Aram Shamamian, Midland, MI (US)

(21) Appl. No.: 14/405,858

(22) PCT Filed: May 29, 2013
(86) PCT No.: PCT/US2013/043005

§ 371 Date: Dec. 5, 2014

Related U.S. Application Data
(60) Provisional application No. 61/655,635, filed on Jun. 5, 2012.

(51) Int. Cl. B01J 19/00; C01B 33/02; C01B 33/00; C01B 33/021

(52) U.S. Cl. CPC B01J 19/00; B01J 19/0006; C01B 33/021; C01B 33/02; C01B 33/00; B01J 2219/00164
USPC 423/344; 422/187; 423/348

(57) ABSTRACT

A system for preparing nanoparticles is described. The system can include a reactor for producing a nanoparticle aerosol comprising nanoparticles in a gas. The system also includes a diffusion pump that has a chamber with an inlet and an outlet. The inlet of the chamber is in fluid communication with an outlet of the reactor. The diffusion pump also includes a reservoir in fluid communication with the chamber for supporting a diffusion pump fluid and a heater for vaporizing the diffusion pump fluid in the reservoir to a vapor. In addition, the diffusion pump has a jet assembly in fluid communication with the reservoir having a nozzle for discharging the vaporized diffusion pump fluid into the chamber. The system can further include a vacuum pump in fluid communication with the outlet of the chamber. A method of preparing nanoparticles is also provided.

### FIELD

The present disclosure is directed generally to nanoparticles and more particularly to capturing of nanoparticles.

### BACKGROUND

The statements in this section merely provide background information related to the present disclosure and may not constitute prior art.

The advent of nanotechnology is resulting in a paradigm shift in many technological arts because the properties of many materials change at nanoscale dimensions. For example, decreasing the dimensions of some structures to nanoscale can increase the ratio of surface area to volume, thus causing changes in the electrical, magnetic, reactive, chemical, structural, and thermal properties of the material. Nanomaterials are already being found in commercial applications and will likely be present in a wide variety of technologies including computers, photovoltaics, optoelectronics, medicine/pharmaceuticals, structural materials, military applications, and many others within the next few decades.

### SUMMARY

Described herein are systems and methods of liquid capturing of nanoparticles from an aerosol of nanoparticles and gas. Certain methods of preparation include the use of a reactor (e.g., low pressure high frequency pulsed plasma reactor) and direct fluid capture of the nanoparticles formed in the reactor by a diffusion pump.

According to one form of the present disclosure, a system is provided. The system can include a reactor for producing a nanoparticle aerosol comprising nanoparticles in a gas. The reactor has a precursor gas inlet and an outlet. The system also includes a diffusion pump that has a chamber with an inlet and an outlet. The inlet of the chamber is in fluid communication with the outlet of the reactor. The diffusion pump also includes a reservoir in fluid communication with the chamber for supporting a diffusion pump fluid and a heater for vaporizing the diffusion pump fluid in the reservoir to a vapor. Furthermore, the diffusion pump has a jet assembly in fluid communication with the reservoir having a nozzle for discharging the vaporized diffusion pump fluid into the chamber. The system further includes a vacuum pump in fluid communication with the outlet of the chamber of the diffusion pump.

According to another form of the present disclosure, a method of preparing nanoparticles is provided. The method includes forming a nanoparticle aerosol in a reactor. The nanoparticle aerosol comprises nanoparticles in a gas, and the method further includes introducing the nanoparticle aerosol into a diffusion pump from the reactor. The method also includes heating a diffusion pump fluid in a reservoir to form a vapor, sending the vapor through a jet assembly, emitting the vapor through a nozzle into a chamber of the diffusion pump, condensing the vapor to form a condensate, and flowing the condensate back to the reservoir. Furthermore, the method includes capturing the nanoparticles of the aerosol in the condensate and collecting the captured nanoparticles in the reservoir.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic of an example system with a low pressure pulsed plasma reactor which can be used to prepare nanoparticles and a diffusion pump to collect the nanoparticles in accordance with forms of the present disclosure;

FIG. 2 is a schematic of an example diffusion pump which can be used to collect nanoparticles in accordance with forms of the present disclosure;

FIG. 3 is a photograph of a system with a plasma reactor for producing nanoparticles and a diffusion pump for collecting the nanoparticles;

FIG. 4a is a photograph of silicone oil in the diffusion pump without nanoparticles;

FIG. 4b is a photograph of silicon oil in the diffusion pump after the nanoparticles were deposited into the silicon oil;

FIG. 5a is a bright field transmission electron microscope (TEM) image of the silicon nanoparticles captured in the silicon oil from the diffusion pump;

FIG. 5b is an electron diffraction pattern of the silicon nanoparticles captured in the silicon oil from the diffusion pump with the crystal planes for silicon labeled;

FIG. 6a is another bright field TEM image of the silicon nanoparticles captured in the silicon oil from the diffusion pump;

FIG. 6b is another electron diffraction pattern of the silicon nanoparticles captured in the silicon oil from the diffusion pump with the crystal planes for silicon labeled; and

FIG. 7 is a plot of particle diameter (nm) measured from the TEM for three diffusion pump runs.

### DETAILED DESCRIPTION

The following description is merely exemplary in nature and is in no way intended to limit the present disclosure or its application or uses. It should be understood that throughout the description, corresponding reference numerals indicate like or corresponding parts and features.

The present disclosure describes systems having a reactor for producing a nanoparticle aerosol (e.g., nanoparticles in a gas) and a diffusion pump in fluid communication with the reactor for collecting the nanoparticles of the aerosol. Also described herein are methods of preparing nanoparticles and nanoparticles produced according to such methods.

Inventors have discovered that nanoparticles of various size distributions and properties can be prepared by introducing a nanoparticle aerosol produced in a reactor (e.g., a low-pressure plasma reactor) into a diffusion pump in fluid communication with the reactor, capturing the nanoparticles of the aerosol in a condensate from a diffusion pump oil, liquid, or fluid (e.g., silicone fluid), and collecting the captured nanoparticles in a reservoir. This method is both cost-effective and scalable to a high throughput manufacturing process.

Examples of reactors and methods of producing nanoparticle aerosols are described herein as well as diffusion pumps and methods of collecting nanoparticles. Although specific examples of reactors may be described herein, other reactors may also be used to generate the nanoparticle aerosol. For example, a diffusion pump can be used to collect nanoparticles of an aerosol produced by virtually any type of reactor capable of producing nanoparticle aerosols.

Example reactors are described in WO 2010/027959 and WO 2011/109229, each of which is incorporated by reference in its entirety herein. Such reactors can be, but are not limited to, low pressure high frequency pulsed plasma reactors, and nanoparticles that can be produced include, but are not limited to, nanoparticles that comprise or consist essentially of silicon. In particular, although the examples below may be described with regard to silicon nanoparticles, nanoparticles that comprise other materials and alloys can be produced and captured using the described systems and methods.

According to one aspect of the present disclosure, a system includes a reactor for producing a nanoparticle aerosol comprising nanoparticles in a gas. The reactor can include a precursor gas inlet and an outlet. The system can further include a diffusion pump comprising a chamber having an inlet and an outlet. The inlet of the chamber is in fluid communication with the outlet of the reactor. The diffusion pump can further include a reservoir in fluid communication with the chamber for supporting a diffusion pump fluid, a heater for vaporizing the diffusion pump fluid in the reservoir to a vapor, and a jet assembly in fluid communication with the reservoir comprising a nozzle for discharging the vaporized diffusion pump fluid into the chamber. The system can further include a vacuum pump in fluid communication with the outlet of the chamber.

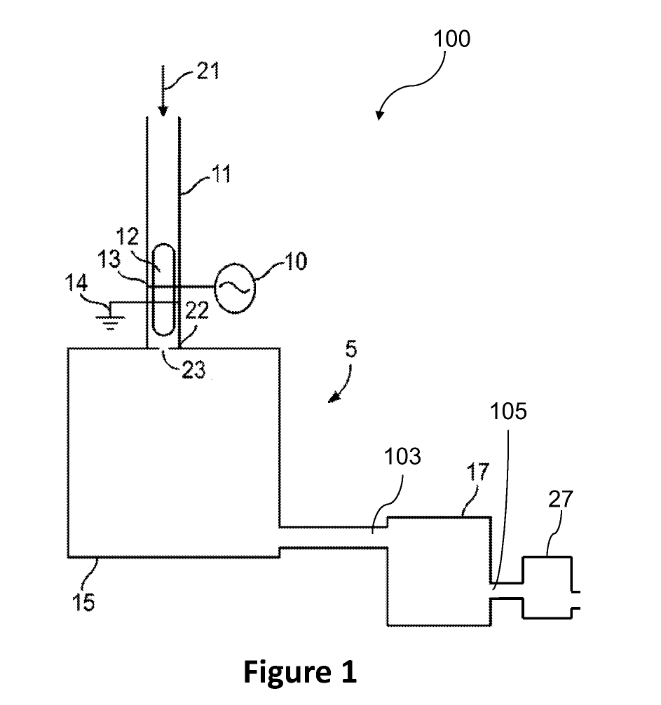

FIG. 1 is a schematic of an example system 100 that includes a reactor 5 for producing a nanoparticle aerosol comprising nanoparticles in a gas. The reactor 5 may be a pulsed plasma reactor. For example, the reactor 5 may comprise a plasma generating chamber 11 having the precursor gas inlet 21 and the outlet 22. The reactor 5 may have at least one flow rate controller for controlling a rate of introducing the precursor gas into the reactor 5. The outlet may have an aperture or orifice 23 therein. The plasma generating chamber 11 may comprise an electrode configuration 13 that is attached to a variable frequency rf amplifier 10. The plasma generating chamber 11 also may comprise a second electrode configuration 14. The second electrode configuration 14 may be either ground, DC biased, or operated in a push-pull manner relative to the electrode 13. The electrodes 13, 14 are used to couple the very high frequency (VHF) power to the precursor gas to ignite and sustain a glow discharge of plasma within the area identified as 12. The precursor gas can then be dissociated in the plasma to provide charged atoms which nucleate to form nanoparticles. For example, the at least one precursor gas may comprise a gas having a Group IV element, such as silicon and/or germanium. These Group designations of the periodic table are generally from the CAS or old IUPAC nomenclature, although Group IV elements are referred to as Group 14 elements under the modern IUPAC system, as readily understood in the art.

To control the diameter of the nanoparticles which are formed, the distance between the aperture 23 in the outlet 22 of plasma generating chamber 11 and the diffusion pump 17 may range between about 5 to about 50 aperture diameters. Positioning the diffusion pump 17 too close to the outlet of the plasma generating chamber 11 may result in undesirable interactions of plasma with the fluid of the diffusion pump 17. Conversely, positioning the diffusion pump 17 too far from the aperture 23 reduces particle collection efficiency. As collection distance is a function of the aperture diameter of the outlet 22 and the pressure drop between the plasma generating chamber 11 and the diffusion pump 17, based on the operating condition described herein, a collection distance may be from about 1 to about 20 cm or from about 5 to about 10 cm. Stated another way, a collection distance may be from about 5 to about 50 aperture diameters.

The system 5 may also comprise a power source or supply. The power can be supplied via a variable frequency radio frequency power amplifier 10 that is triggered by an arbitrary function generator to establish high frequency pulsed plasma in area 12. The radio frequency power may be capacitively coupled into the plasma using a ring electrode, parallel plates, or an anode/cathode setup in the gas. The radio frequency power may also be inductively coupled mode into the plasma using an rf coil setup around the discharge tube.

The plasma generating chamber 11 may also comprise a dielectric discharge tube. The precursor gas enters the dielectric discharge tube where the plasma is generated. Nanoparticles which form from the precursor gas start to nucleate as the precursor gas molecules are dissociated in the plasma.

In one form of the present disclosure, the electrodes 13, 14 for a plasma source inside the plasma generating chamber 11 comprise a flow-through showerhead design in which a VHF radio frequency biased upstream porous electrode plate 13 is separated from a downstream porous electrode plate 14, with the pores of the plates aligned with one another. The pores may be circular, rectangular, or any other desirable shape. The plasma generating chamber 11 may also enclose an electrode 13 that is coupled to the VHF radio frequency power source and has a pointed tip that has a variable distance between the tip and a grounded ring inside the chamber 11.

The system 100 can further include a diffusion pump 17. As such, the silicon nanoparticles can be collected by the diffusion pump 17. A particle collection chamber 15 may be in fluid communication with the plasma generating chamber 11. The diffusion pump 17 may be in fluid communication with the particle collection chamber 15 and the plasma generating chamber 11. In other forms of the present disclosure, the system 100 may not include the particle collection chamber 15. For example, the outlet 22 may be coupled to an inlet 103 of the diffusion pump 17, or the diffusion pump 17 may be in substantially direct fluid communication with the plasma generating chamber 11.

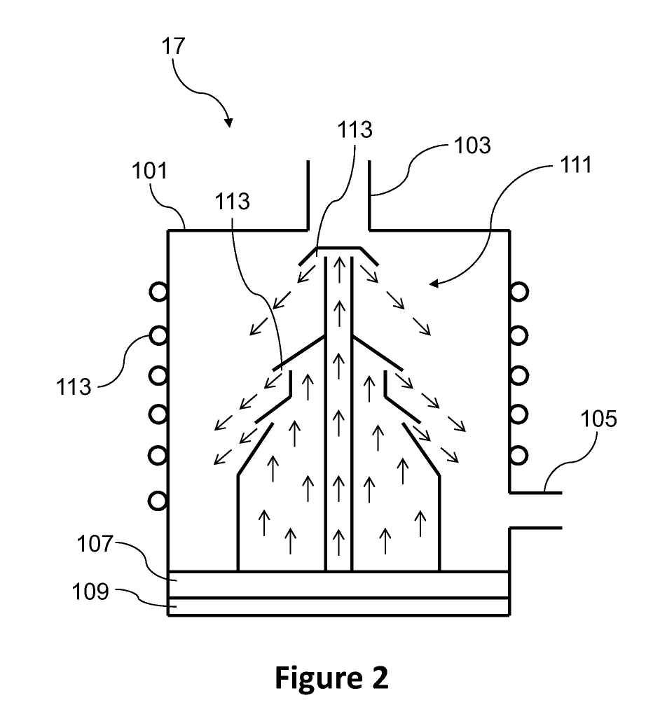

FIG. 2 is a cross-sectional schematic of an example diffusion pump 17. The diffusion pump 17 can include a chamber 101 having an inlet 103 and an outlet 105. The inlet 103 may have a diameter of about 2 to about 55 inches, and the outlet may have a diameter of about 0.5 to about 8 inches. The inlet 103 of the chamber 101 is in fluid communication with the outlet 22 of the reactor 5. The diffusion pump 17 may have, for example, a pumping speed of about 65 to about 65,000 liters/second or greater than about 65,000 liters/second.

The diffusion pump 17 includes a reservoir 107 in fluid communication with the chamber 101. The reservoir 107 supports or contains a diffusion pump fluid. The reservoir may have a volume of about 30 cc to about 15 liters. The volume of diffusion pump fluid in the diffusion pump may be about 30 cc to about 15 liters.

The diffusion pump 17 can further include a heater 109 for vaporizing the diffusion pump fluid in the reservoir 107 to a vapor. The heater 109 heats up the diffusion pump fluid and vaporizes the diffusion pump fluid to form a vapor (e.g., liquid to gas phase transformation). For example, the diffusion pump fluid may be heated to about 100 to about 400° C. or about 180 to about 250° C.

A jet assembly 111 can be in fluid communication with the reservoir 107 comprising a nozzle 113 for discharging the vaporized diffusion pump fluid into the chamber 101. The vaporized diffusion pump fluid flows and rises up though the jet assembly 111 and emitted out the nozzles 113. The flow of the vaporized diffusion pump fluid is illustrated in FIG. 2 with arrows. The vaporized diffusion pump fluid condenses and flows back to the reservoir 107. For example, the nozzle 113 can discharge the vaporized diffusion pump fluid against a wall of the chamber 101. The walls of the chamber 101 may be cooled with a cooling system 113 such as a water cooled system. The cooled walls of the chamber 101 can cause the vaporized diffusion pump fluid to condense. The condensed diffusion pump fluid can then flow along and down the walls of the chamber 101 and back to the reservoir 107. The diffusion pump fluid can be continuously cycled through diffusion pump 17. The flow of the diffusion pump fluid causes gas that enters the inlet 103 to diffuse from the inlet 103 to the outlet 105 of the chamber 101. A vacuum source 27 as previously described can be in fluid communication with the outlet 105 of the chamber 101 to assist removal of the gas from the outlet 105.

As the gas flows through the chamber, nanoparticles in the gas can be absorbed by the diffusion pump fluid thereby collecting the nanoparticles from the gas. For example, a surface of the nanoparticles may be wetted by the vaporized and/or condensed diffusion pump fluid. Furthermore, the agitating of cycled diffusion pump fluid may further improve absorption rate of the nanoparticles compared to a static fluid. The pressure within the chamber 101 may be less than about 1 mTorr.

The diffusion pump fluid with the nanoparticles can then be removed from the diffusion pump 17. For example, the diffusion pump fluid with the nanoparticles may be continuously removed and replaced with diffusion pump fluid that substantially does not have nanoparticles.

Advantageously, the diffusion pump 17 can be used not only for collecting nanoparticles but also evacuating the reactor 5 (and collection chamber 15). For example, the operating pressure in the reactor 5 can be a low pressure such as less than atmospheric pressure, less than 760 Torr, or between about 1 and about 760 Torr. The collection chamber 15 can, for example, range from about 1 to about 5 millitorr. Other operating pressures are also contemplated.

The diffusion pump fluid can be selected to have the desired properties for nanoparticle capture and storage. Fluids that may be used as the diffusion pump fluid include, but are not limited to, silicone fluids. For example, silicone fluids such as polydimethylsiloxane, mixed phenylmethyl-dimethyl cyclosiloxane, tetramethyltetraphenyltrisiloxane, and penta phenyltrimethyltrisiloxane are all suitable for use as diffusion pump fluids. Other diffusion pump fluids and oils may include hydrocarbons, phenyl ethers, fluorinated polyphenyl ethers, and ionic fluids. The fluid may dynamic viscosity of from about 0.001 to about 1 Pa·s, about 0.001 to about 0.5 Pa·s, or about 0.01 to about 0.2 Pa·s at 23±3° C. Furthermore, the fluid may have a vapor pressure of less than about 1×10⁻⁴ Torr.

The system 100 may also include a vacuum pump or vacuum source 27 in fluid communication with the outlet 105 of the diffusion pump 17. The vacuum source 27 can be selected in order for the diffusion pump 17 to operate properly. In one form of the present disclosure, the vacuum source 27 comprises a vacuum pump (e.g., auxiliary pump). The vacuum source 27 may comprise a mechanical, turbo molecular, or cryogenic pump. However, other vacuum sources are also contemplated.

According to one form of the present disclosure, a method of preparing nanoparticles is provided. The method can include forming a nanoparticle aerosol in a reactor 5. The nanoparticle aerosol can comprise nanoparticles in a gas, and the method further includes introducing the nanoparticle aerosol into a diffusion pump 17 from the reactor 5. The method also may include heating a diffusion pump fluid in a reservoir 107 to form a vapor, sending the vapor through a jet assembly 111, emitting the vapor through a nozzle 113 into a chamber 101 of the diffusion pump 5, condensing the vapor to form a condensate, and flowing the condensate back to the reservoir 107. Furthermore, the method can further include capturing the nanoparticles of the aerosol in the condensate and collecting the captured nanoparticles in the reservoir 107. The method can further include removing the gas from the diffusion pump with a vacuum pump.

Forming a nanoparticle aerosol in the reactor 5 can be performed by a variety of methods. For example, the nanoparticle aerosol may be formed from at least one precursor gas. The precursor gas may contain silicon. Furthermore, the precursor gas may be selected from silanes, disilanes, halogen-substituted silanes, halogen-substituted disilanes, C1-C4 alkyl silanes, C1 to C4 alkyldisilanes, and mixtures thereof. In one form of the present disclosure, precursor gas may comprise silane which comprises from about 0.1 to about 2% of the total gas mixture. However, the gas mixture may also comprise other percentages of silane. Alternatively, the precursor gas may also comprise, but is not limited to, SiCl₄, HSiCl₃, and H₂SiCl₂.

The precursor gas may be mixed with other gases such as inert gases to form a gas mixture. Examples of inert gases that may be included in the gas mixture include argon, xenon, neon, or a mixture of inert gases. When present in the gas mixture, the inert gas may comprise from about 1% to about 99% of the total volume of the gas mixture. The precursor gas may have from about 0.1% to about 50% of the total volume of the gas mixture. However, it is also contemplated that the precursor gas may comprise other volume percentages such as from about 1% to about 50% of the total volume of the gas mixture.

In one form of the present disclosure, the reactant gas mixture also comprises a second precursor gas which itself can comprise from about 0.1 to about 49.9 volume % of the reactant gas mixture. The second precursor gas may comprise BCl₃, B₂H₆, PH₃, GeH₄, or GeCl₄. The second precursor gas may also comprise other gases that contain carbon, germanium, boron, phosphorous, or nitrogen. The combination of the first precursor gas and the second precursor gas together may make up from about 0.1 to about 50% of the total volume of the reactant gas mixture.

In another form of the present disclosure, the reactant gas mixture further comprises hydrogen gas. Hydrogen gas can be present in an amount of from about 1% to about 10% of the total volume of the reactant gas mixture. However, it is also contemplated that the reactant gas mixture may comprise other percentages of hydrogen gas.

The method can further include flowing the at least one precursor gas into the reactor 5. In addition, the method can also include generating a plasma from the at least one precursor gas.

Pulsing the plasma enables an operator to directly manage the resident time for particle nucleation, and thereby control the particle size distribution and agglomeration kinetics in the plasma. The pulsing function of the system allows for controlled tuning of the particle resident time in the plasma, which affects the size of the nanoparticles. By decreasing the “on” time of the plasma, the nucleating particles have less time to agglomerate, and therefore the size of the nanoparticles may be reduced on average (e.g., the nanoparticle distribution may be shifted to smaller diameter particle sizes).

Advantageously, the operation of the plasma reactor system 5 at higher frequency ranges, and pulsing the plasma provides the same conditions as in conventional constricted/filament discharge techniques that use a plasma instability to produce the high ion energies/densities, but with the additional advantage that users can control operating conditions to select and produce nanoparticles having sizes which result in photoluminescent properties.

In one form of the present disclosure, the VHF radio frequency power source operates in a frequency range of about 30 to about 500 MHz. In another form of the present disclosure, the pointed tip 13 can be positioned at a variable distance from a VHF radio frequency powered ring 14 operated in a push-pull mode (180° out of phase). In yet another form of the present disclosure, the electrodes 13, 14 include an inductive coil coupled to the VHF radio frequency power source so that radio frequency power is delivered to the precursor gas by an electric field formed by the inductive coil. Portions of the plasma generating chamber 11 can be evacuated to a vacuum level ranging between about 1×10⁻⁷ to about 500 Torr. However, other electrode coupling configurations are also contemplated for use with the method disclosed herein.

The plasma in area 12 may be initiated with a high frequency plasma via an rf power amplifier such as, for example, an AR Worldwide Model KAA2040, or an Electronics and Innovation Model 3200L, or an EM Power RF Systems, Inc. Model BBS2E3KUT. The amplifier can be driven (or pulsed) by an arbitrary function generator (e.g., a Tektronix AFG3252 function generator or a Tektronix AWG7051) that is capable of producing up to 1000 watts of power from 0.15 to 500 MHz. In several forms of the present disclosure, the arbitrary function may be able to drive the power amplifier with pulse trains, amplitude modulation, frequency modulation, or different waveforms. The power coupling between the amplifier and the reactant gas mixture typically increases as the frequency of the rf power increases. The ability to drive the power at a higher frequency may allow more efficient coupling between the power supply and discharge. The increased coupling may be manifested as a decrease in the voltage standing wave ratio (VSWR).

$$VSWR = \frac{1 + p}{1 - p} \qquad ( 1 )$$

where p is the reflection coefficient,

$$p = \frac{Zp - Zc}{Zc + Zp} \qquad ( 2 )$$

with Zₚ and Z_{c} representing the impedance of the plasma and coil respectively. At frequencies below 30 MHz, only 2-15% of the power is delivered to the discharge. This has the effect of producing high reflected power in the rf circuit that leads to increased heating and limited lifetime of the power supply. In contrast, higher frequencies allow more power to be delivered to the discharge, thereby reducing the amount of reflected power in the rf circuit.

In one form of the present disclosure, the power and frequency of the plasma system is preselected to create an optimal operating space for the formation of photoluminescent silicon nanoparticles. Tuning both the power and frequency can create an appropriate ion and electron energy distribution in the discharge to help dissociate the molecules of precursor gas and nucleate the nanoparticles. Appropriate control of both the power and frequency may prevent the nanoparticles from growing too large.

The plasma reactor 5 may be operated at pressures from about 100 mTorr to about 10 Torr in the plasma generating chamber 11 and with a power of from about 1 W to about 1000 W. However, other powers, pressures, and frequencies of the plasma reactor 5 are also contemplated.

For a pulse injection, the synthesis of the nanoparticles can be done with a pulsed energy source, such as a pulsed very high frequency rf plasma, a high frequency rf plasma, or a pulsed laser for pyrolysis. The VHF radiofrequency may be pulsed at a frequency ranging from about 1 to about 50 kHz. However, it is also contemplated that the VHF radiofrequency may be pulsed at other frequencies.

Another method to transfer the nanoparticles to the diffusion pump is to pulse the input of the reactant gas mixture while the plasma is ignited. For example, the plasma can be ignited in which a precursor gas is present is ignited to synthesize the nanoparticles with at least one other gas present to sustain the discharge such as an inert gas. The nanoparticle synthesis is stopped when the flow of the precursor gas is stopped with a mass flow controller. The synthesis of the nanoparticles continues when the flow of the precursor gas is started again. This produces a pulsed stream of nanoparticles. This technique can be used to increase the concentration of nanoparticles in the diffusion pump fluid if the flux of nanoparticles impinging on the diffusion pump fluid is greater than the absorption rate of the nanoparticles into the diffusion pump fluid.

Generally, the nanoparticles can be synthesized at increased plasma residence time relative to the precursor gas molecular residence time through a VHF radio frequency low pressure plasma discharge. Alternatively, crystalline nanoparticles can be synthesized at lower plasma residence times at the same operating conditions of discharge drive frequency, drive amplitude, discharge tube pressure, chamber pressure, plasma power density, gas molecule residence time through the plasma, and collection distance from plasma source electrodes. In one form of the present disclosure, the mean particle diameter of nanoparticles can be controlled by controlling the plasma residence time and a high ion energy/density region of a VHF radio frequency low pressure glow discharge can be controlled relative to at least one precursor gas molecular residence time through the discharge.

The size distribution of the nanoparticles can also be controlled by controlling the plasma residence time, a high ion energy/density region of the VHF radio frequency low pressure glow discharge relative to said at least one precursor gas molecular residence time through the discharge. The lower the plasma residence time of a VHF radio frequency low pressure glow discharge relative to the gas molecular residence time, the smaller the mean nanoparticle diameter can be at constant operating conditions. The operating conditions may be defined by the discharge drive frequency, drive amplitude, discharge tube pressure, chamber pressure, plasma power density, precursor mass flow rates, and collection distance from plasma source electrodes. However, other operating conditions are also contemplated. For example, as the plasma residence time of a VHF radio frequency low pressure glow discharge relative to the gas molecular residence time increases, the mean nanoparticle diameter follows an exponential growth model of y=y₀−exp (−tᵣ/C), where y is the mean nanoparticle diameter, y₀ is the offset, tᵣ is the plasma residence time, and C is a constant. The particle size distribution may also increase as the plasma residence time increases under otherwise constant operating conditions.

In another form of the present disclosure, the mean particle diameter of the nucleated nanoparticles (as well as the nanoparticle size distribution) can be controlled by controlling a mass flow rate of at least one precursor gas in a VHF radio frequency low pressure glow discharge. For example, the reactor can include at least one flow rate controller for controlling a rate of introducing at least one precursor gas into the reactor. As the mass flow rate of precursor gas (or gases) increases in the VHF radio frequency low pressure plasma discharge, the synthesized mean nanoparticle diameter may decrease following an exponential decay model of the form y=y₀+exp (−MFR/C′), where y is the mean nanoparticle diameter, y₀ is the offset, MFR is the precursor mass flow rate, and C is a constant, for constant operating conditions. Operating conditions may include discharge drive frequency, drive amplitude, discharge tube pressure, chamber pressure, plasma power density, gas molecule residence time through the plasma, and collection distance from plasma source electrodes. The synthesized mean core nanoparticle particle size distribution may also decrease as an exponential decay model of the form y=y₀+exp (−MFR/K), where y is the mean nanoparticle diameter, y₀ is the offset, MFR is the precursor mass flow rate, and K is a constant, for constant operating conditions.

The method can further include introducing the nanoparticle aerosol into a diffusion pump 17 from the reactor 5. The nanoparticles may be evacuated from chamber 11 to the diffusion pump 17 by cycling the plasma to a low ion energy state, or by turning the plasma off.

In another form of the present disclosure, the nucleated nanoparticles are transferred from the plasma generating chamber 11 to the diffusion pump 17 via an aperture or orifice 23 which creates a pressure differential. For example, the diffusion pump may be in fluid communication with the reactor. Furthermore, the method may include evacuating the reactor with the diffusion pump. It is contemplated that the pressure differential between the plasma generating chamber 11 and diffusion pump 17 can be controlled through a variety of means. In one configuration, the inside diameter of the plasma generating chamber 11 is much less than the inside diameter of the particle collection chamber 15 or diffusion pump 17 chamber, thus creating a pressure drop. In another configuration, a grounded physical aperture or orifice may be placed between the discharge tube and the collection chamber 15 or diffusion pump 17 chamber that forces the plasma to reside partially inside the orifice, based on the Debye length of the plasma and the size of the particle collection chamber 15 or diffusion pump 17 chamber. Another configuration comprises using a varying electrostatic orifice in which a positive concentric charge is developed that force the negatively charged plasma through the aperture 23.

Upon transfer to the diffusion pump 17, the nucleated nanoparticles can be absorbed into the diffusion pump fluid. For example, the method can include capturing the nanoparticles of the aerosol in the condensate and collecting the captured nanoparticles in the reservoir. Furthermore, the method may include wetting a surface of the nanoparticles with the vapor.

The diffusion pump fluid may comprise silicone fluid. Furthermore, the diffusion pump fluid may comprise at least one fluid selected from the group consisting of hydrocarbons, phenyl ethers, fluorinated polyphenyl ethers, and ionic fluids. The diffusion pump fluid may have a dynamic viscosity of from about 0.001 to about 1 Pa·s, about 0.001 to about 0.5 Pa·s, or about 0.01 to about 0.2 Pa·s at 23±3° C. The diffusion pump fluid may also have any property as those discussed above.

It is contemplated that the diffusion pump fluid may be used as a material handling and storage medium. In one form of the present disclosure, the diffusion pump fluid is selected to allow nanoparticles to be absorbed and disperse into the fluid as they are collected, thus forming a dispersion or suspension of nanoparticles in the diffusion pump fluid. Nanoparticles can be adsorbed into the fluid if they are miscible with the fluid.

Nanoparticles can be prepared by any of the methods described above. Furthermore, the diffusion pump 17 can be used to collect nanoparticles from a variety of nanoparticle aerosols. For example, the nanoparticles may have a largest dimension or average largest dimension less than about 50 nm, less than about 20 nm, less than about 10 nm, or less than about 5 nm. Furthermore, the largest dimension or average largest dimension of the nanoparticles may be between about 1 and about 50 nm, between about 2 and about 50 nm, between about 2 and about 20 nm, between about 2 and 10 nm, or between about 2.2 and about 4.7 nm. Other sized nanoparticles are also able to be collected with the diffusion pump 17. The nanoparticles can be measured by a variety of means such as with a transmission electron microscope (TEM). For example, as understood in the art, particle size distributions are often calculated via TEM image analysis of hundreds of different nanoparticles.

Upon the dissociation of the precursor gas in the plasma generation chamber 11, nanoparticles form and are entrained in the gas phase. The distance between the nanoparticle synthesis location and the diffusion pump fluid can be short enough so that no unwanted functionalization occurs while the nanoparticles are entrained. If particles interact within the gas phase, agglomerations of numerous individual small particles may form and be captured in the diffusion pump fluid. If too much interaction takes place within the gas phase, the particles may sinter together and form particles larger than 5 nm in diameter. The collection distance can be defined as the distance from the outlet of the plasma generating chamber to the diffusion pump fluid. In one form of the present disclosure, the collection distance ranges from about 5 to about 50 aperture diameters. The collection distance may also range from about 1 to about 20 cm, between about 6 and about 12 cm, or from about 5 to about 10 cm. However, other collection distances are also contemplated.

In one form of the present disclosure, the nanoparticles may comprise silicon alloys. Silicon alloys that may be formed include, but are not limited to, silicon carbide, silicon germanium, silicon boron, silicon phosphorous, and silicon nitride. The silicon alloys may be formed by mixing at least one first precursor gas with the second precursor gas or using a precursor gas that contains the different elements. However, other methods of forming alloyed nanoparticles are also contemplated.

In another form of the present disclosure, the silicon nanoparticles may undergo an additional doping step. For example, the silicon nanoparticles may undergo gas phase doping in the plasma, where a second precursor gas is dissociated and is incorporated in the silicon nanoparticles as they are nucleated. The silicon nanoparticles may also undergo doping in the gas phase downstream of the production of the nanoparticles, but before the silicon nanoparticles are captured in the liquid. Furthermore, doped silicon nanoparticles may also be produced in the diffusion pump fluid where the dopant is preloaded into the diffusion pump fluid and interacts with the nanoparticles after they are captured. Doped nanoparticles can be formed by contact with organosilicon gases or liquids, including, but not limited to trimethylsilane, disilane, and trisilane. Gas phase dopants may include, but are not limited to, BCl₃, B₂H₆, PH₃, GeH₄, or GeCl₄.

The direct liquid capture of the nanoparticles in fluid provides unique properties of the composition. For example, the collected nanoparticles may be photoluminescent. Silicon nanoparticles that are directly captured in a diffusion pump fluid show visible photoluminescence when removed from the system and excited by exposure to UV light. Depending on the average diameter of the nanoparticles, they may photoluminescence in any of the wavelengths in the visible spectrum and may visually appear to be red, orange, green, blue, violet, or any other color in the visible spectrum. For example, nanoparticles with an average diameter less than about 5 nm may produce visible photoluminescence, and nanoparticles with an average diameter less than about 10 nm may produce near infrared (IR) luminescence. In one form of the present disclosure, the photoluminescent silicon nanoparticles which are directly captured have a photoluminescent intensity of at least 1×10⁶ at an excitation wavelength of about 365 nm. The photoluminescent intensity may be measured with a Fluorolog3 spectrofluorometer (commercially available from Horiba of Edison, N.J.) with a 450 W Xe excitation source, excitation monochromator, sample holder, edge band filter (400 nm), emission monochromator, and a silicon detector photomultiplier tube. To measure photoluminescent intensity, the excitation and emission slit width are set to 2 nm and the integration time is set to 0.1 s. In these or other embodiments, the photoluminescent silicon nanoparticles may have a quantum efficiency of at least 4% at an excitation wavelength of about 395 nm as measured on an HR400 spectrophotometer (commercially available from Ocean Optics of Dunedin, Fla.) via a 1000 micron optical fiber coupled to an integrating sphere and the spectrophotometer with an absorption of >10% of the incident photons. Quantum efficiency was calculated by placing a sample into the integrating sphere and exciting the sample via a 395 nm LED driven by an Ocean Optics LED driver. The system was calibrated with a known lamp source to measure absolute irradiance from the integrating sphere. The quantum efficiency was then calculated by the ratio of total photons emitted by the nanoparticles to the total photons absorbed by the nanoparticles.

Furthermore, both the photoluminescent intensity and luminescent quantum efficiency of the direct capture composition may continue to increase over time when the nanoparticle containing diffusion pump fluid is exposed to air. In another form of the present disclosure, the maximum emission wavelength of the nanoparticles directly captured in a fluid shift to shorter wavelengths over time when exposed to oxygen. The luminescent quantum efficiency of the directly captured silicon nanoparticle composition may be increased by about 200% to about 2500% upon exposure to oxygen. However, other increases in the luminescent quantum efficiency are also contemplated. The photoluminescent intensity may increase from 400 to 4500% depending on the time exposure to oxygen and the concentration of the silicon nanoparticles in the fluid. However, other increases in the photoluminescent intensity are also contemplated. The wavelength emitted from the direct capture composition also experiences a blue shift of the emission spectrum. In one form of the present disclosure, the maximum emission wavelength shifts about 100 nm, based on about a 1 nm decrease in silicon core size, depending on the time exposed to oxygen. However, other maximum emission wavelength shifts are also contemplated.

In one form of the present disclosure, because the direct capture composition experiences increases in luminescent quantum efficiency and photoluminescent intensity upon exposure to oxygen, there may be no need for a moisture barrier in a capping layer that may be used for the particles.

In another form of the present disclosure, the diffusion pump fluid containing silicon nanoparticles is passivated by exposing the fluid to an oxygen containing environment. In another form of the present disclosure, the diffusion pump fluid containing silicon nanoparticles may be passivated with other means. One such means of passivation may be by forming a nitride surface layer on the silicon core nanoparticles, by bubbling a nitrogen-containing gas such as ammonia gas into the diffusion pump fluid.

### Example

### Producing and Capturing Silicon Nanoparticles

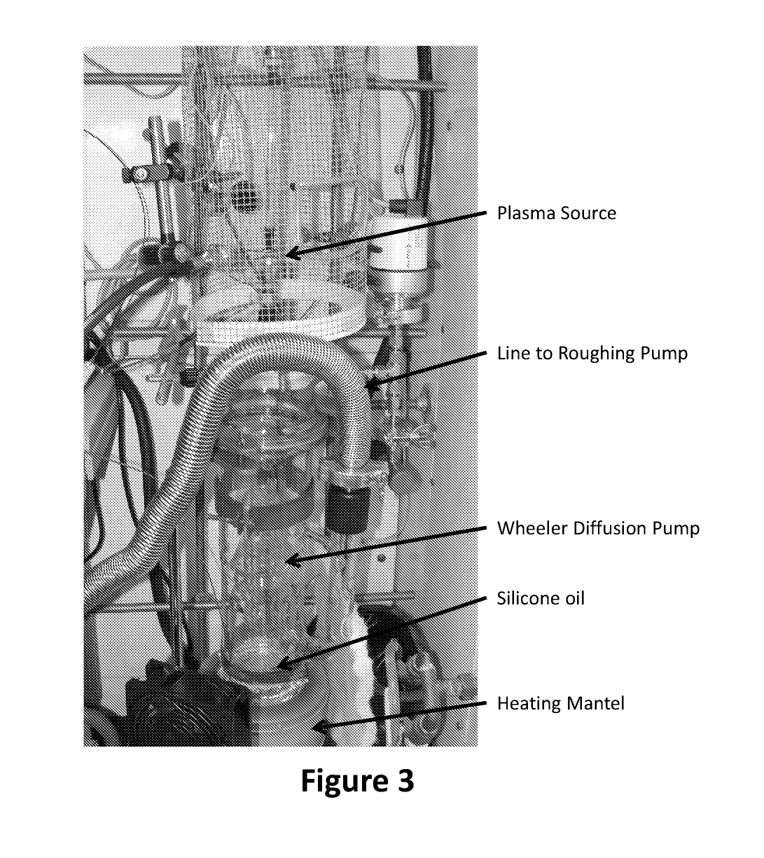

FIG. 3 is a photograph of an example system. A glass Wheeler Diffusion pump was used as the diffusion pump. 250 ml of a silicone fluid was used as the diffusion pump oil. A 10 cubic feet per minute (cfm) mechanical pump was attached to the Wheeler pump as a roughing pump. The 250 ml of silicone fluid was heated to boiling under vacuum via a heating manifold and temperature controller.

The nanoparticle source was a high frequency SiH₄ plasma that was directly upstream of the diffusion pump. The gas composition was 10 standard cubic centimeters per minute (sccm) SiH₄ (2% vol. in Ar) and 6 sccm H₂. The coupled plasma power was 120 W at 127 MHz. A stainless steel orifice was used between the plasma and diffusion pump to produce a large pressure drop that directed the particles into the diffusion pump.

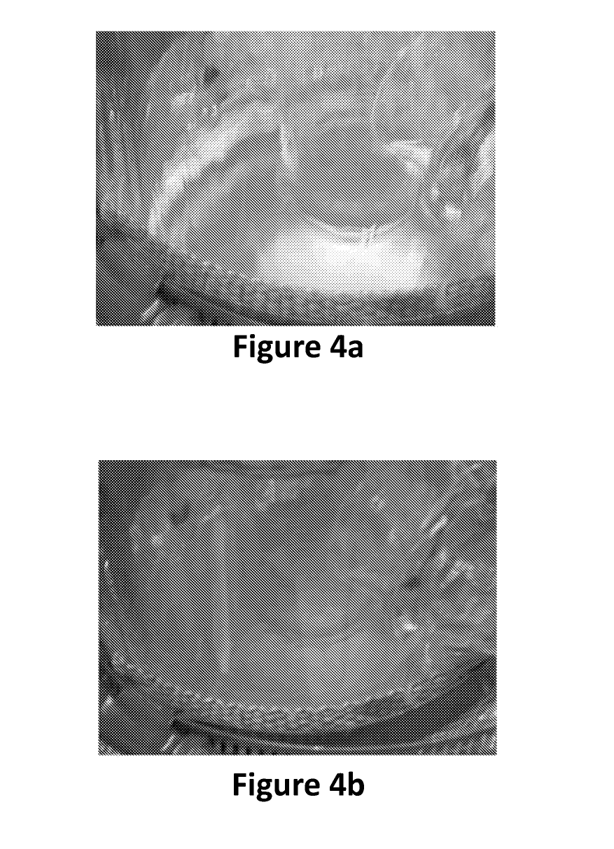

The particles created in the plasma were injected into the diffusion pump due to the pressure drop. As the particles entered the pump, the aerosol pump oil wetted the surface of the nanoparticles and condensed around the particles. As the oil refluxed, the particles were pulled into the boiling bath. The particles collected in the oil during the run. After the run, the oil and particles were poured out of the pump and collected. FIG. 4a is a photograph of the silicon oil without nanoparticles and FIG. 4b is photograph of the silicon oil after nanoparticles were collected. The silicon oil without the nanoparticles was clear while the silicon oil with the nanoparticles had a color.

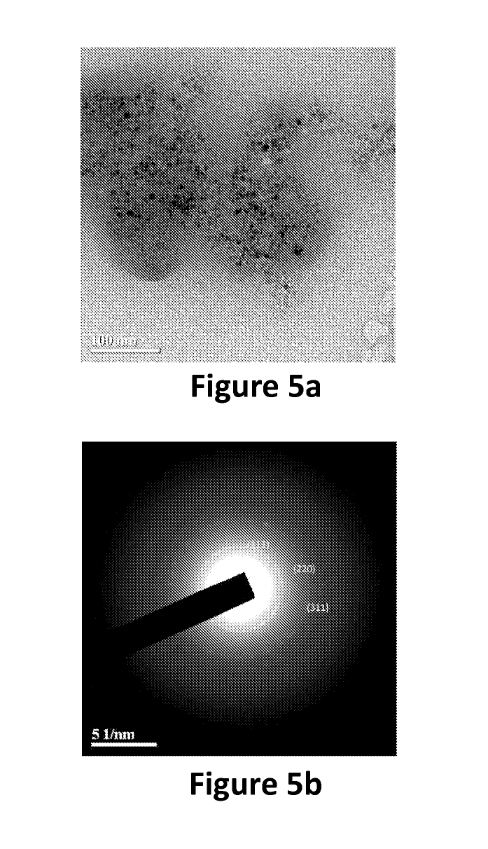

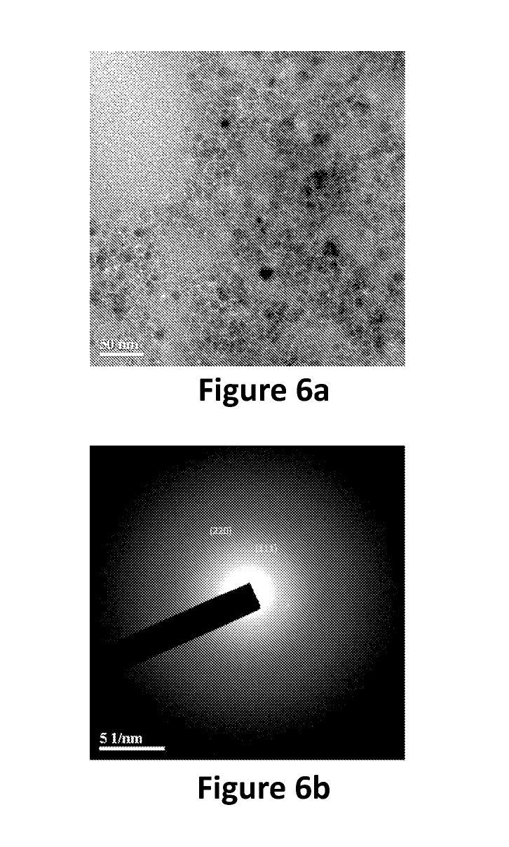

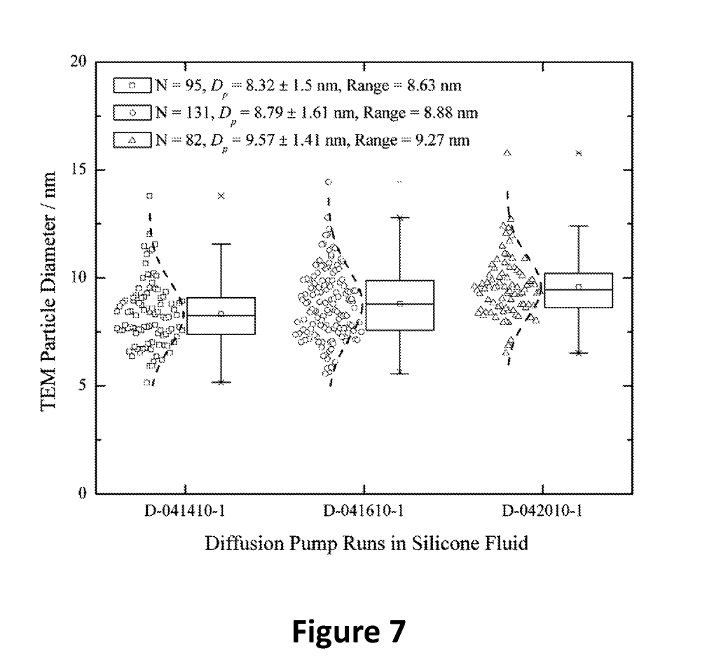

FIGS. 5a and 6a are transmission electron microscope (TEM) images obtained of the Si nanoparticles captured in the silicone fluids. FIGS. 5b and 6b are electron diffraction patterns of the Si nanoparticles of FIGS. 5a and 6a, respectively, which indicate that the particles are crystalline. FIG. 7 is a plot of size of particles for three separate runs. The mean particle diameters with a standard deviation were 8.32±1.5, 8.79±1.61, and 9.57±1.41 nm.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A system comprising:
a reactor for producing a nanoparticle aerosol comprising nanoparticles in a gas, wherein the reactor comprises a precursor gas inlet and an outlet;
a diffusion pump comprising:
a chamber having an inlet and an outlet, wherein the inlet of the chamber is in fluid communication with the outlet of the reactor;
a reservoir in fluid communication with the chamber for supporting a diffusion pump fluid;
a heater for vaporizing the diffusion pump fluid in the reservoir to a vapor; and
a jet assembly in fluid communication with the reservoir comprising a nozzle for discharging the vaporized diffusion pump fluid into the chamber; and
a vacuum pump in fluid communication with the outlet of the chamber.

2. The system according to claim 1, wherein the reactor further comprises at least one flow rate controller for controlling a rate of introducing at least one precursor gas into the reactor.

3. The system according to claim 2, wherein the at least one precursor gas comprises a gas comprising a Group IV element.

4. The system according to claim 1, further comprising a power source for powering the reactor.

5. The system according to claim 1, wherein the reactor is pulsed plasma reactor.

6. The system according to claim 1, wherein the nozzle discharges the vaporized diffusion pump fluid against a cooled wall of the chamber.

7. A method of preparing nanoparticles, the method comprising:
forming a nanoparticle aerosol in a reactor, wherein the nanoparticle aerosol comprises nanoparticles in a gas;
introducing the nanoparticle aerosol into a diffusion pump from the reactor;
heating a diffusion pump fluid in a reservoir to form a vapor and sending the vapor through a jet assembly;
emitting the vapor through a nozzle into a chamber of the diffusion pump and condensing the vapor to form a condensate;
flowing the condensate back to the reservoir;
capturing the nanoparticles of the aerosol in the condensate; and
collecting the captured nanoparticles in the reservoir.

8. The method according to claim 7, wherein the collected nanoparticles are photoluminescent.

9. The method according to claim 7, wherein the diffusion pump fluid comprises a silicone fluid.

10. The method according to claim 7, wherein the diffusion pump fluid comprises at least one fluid selected from the group consisting of hydrocarbons, phenyl ethers, fluorinated polyphenyl ethers, and ionic fluids.

11. The method according to claim 7, wherein the diffusion pump fluid has a dynamic viscosity of about 0.001 to about 1 Pa·s at 23±3° C.

12. The method according to claim 7, further comprising emitting the vapor through the nozzle against a cooled wall of the chamber and flowing the condensate downwardly along the cooled wall back to the reservoir.

13. The method according to claim 7, further comprising evacuating the reactor with the diffusion pump.

14. The method according to claim 7, further comprising forming the nanoparticle aerosol from at least one precursor gas.

15. The method according to claim 14, further comprising generating a plasma from the at least one precursor gas.

16. (canceled)

17. The method according to claim 7, further comprising wetting a surface of the nanoparticles with the vapor.

18. The method according to claim 7, wherein the nanoparticles have a largest dimension less than about 5 nm.

19. The method according to claim 7, wherein the nanoparticles comprise silicon or silicon alloys.

20. (canceled)

21. The method according to claim 7, further comprising removing the gas from the diffusion pump with a vacuum pump.

22. (canceled)

23. Nanoparticles prepared by the method according claim 7.
